(19) United States
(12) Patent Application Publication
(10) Pub. No.: US 2012/0089908 A1
(43) Pub. Date: Apr. 12, 2012

(54) LEVERAGING GEO-IP INFORMATION TO SELECT DEFAULT AVATAR

(75) Inventor: Ken Miyaki, San Diego, CA (US)

(73) Assignee: Sony Computer Entertainment America, LLC., Foster City, CA (US)

(21) Appl. No.: 12/900,426

(22) Filed: Oct. 7, 2010

(51) Int. Cl. G06F 3/048

(52) U.S. Cl. 715/706; 715/835

(57) ABSTRACT

Default selections presented to a client device can be customized when the client device accesses an online service via a network. A geographic location for the client device can be determined from network address information for the device. Socioeconomic information characteristic of the geographic location can be obtained from a first database. A socioeconomic-factor-dependent default menu selection can be customized according to the socioeconomic information. Supplemental information relevant to the menu selection can be obtained from a second database that maps user feedback that is relevant to the menu selection in that geographic location. The default selection can be updated according to the supplemental information. Updating the default selection may optionally include changing a duration for which a particular selection from a sequence of selections is presented on the client device.

### FIELD OF THE INVENTION

Embodiments of the present invention are related to interactive computer entertainment and more specifically to communication among users of a virtual world.

### BACKGROUND OF THE INVENTION

A virtual world is a simulated environment in which users may interact with each other via one or more computer processors. Users may appear on a video screen in the form of representations referred to as avatars. The degree of interaction between the avatars and the simulated environment is implemented by one or more computer applications that govern such interactions as simulated physics, exchange of information between users, and the like. The nature of interactions among users of the virtual world is often limited by the constraints of the system implementing the virtual world.

The default avatar shown in an online world often times reflects the creator/programmers' own ethnic background or preferences, and rarely shows the consumer what their avatar could be. Specifically in the PlayStation online universe ‘Home’, the default avatar is a white male. People in Asia were slightly alienated by avatar selection screens as presented by PlayStation Home due to European characteristics of the avatars in the lobby space. In addition, games tend to reflect the social background of the engineers who make them. Games will tend to take on those social characteristics as a default. E.g., if engineers are mostly male, the games tend to reflect a male mentality. For example, Free Realms is a role-playing game (RPG) from Sony Online Entertainment (SOE) that allows players to create characters and choose costumes. Most users chose avatars that looked like themselves. Most boys chose male avatars. Virtual worlds such as Home that let users create avatars lack the ability to facilitate avatar selection.

It is within this context that embodiments of the present invention arise.

### BRIEF DESCRIPTION OF THE DRAWINGS

The teachings of the present invention can be readily understood by considering the following detailed description in conjunction with the accompanying drawings, in which:

FIG. 1 a schematic diagram of a virtual world system that may be used in conjunction with embodiments of the present invention.

FIG. 2A is a block diagram illustrating a method for leveraging geo-ip to select default avatar according to an embodiment of the present invention.

FIG. 2B is a flow diagram of a virtual world system for selecting default avatar according to an embodiment of the present invention.

FIG. 3 is a block diagram of a cell processor implementation of a video game apparatus according to an embodiment of the present invention.

FIG. 4 illustrates an example of a non-transitory computer-readable storage medium with instructions for implementing default menu selections in accordance with an embodiment of the present invention.

### DESCRIPTION OF THE SPECIFIC EMBODIMENTS

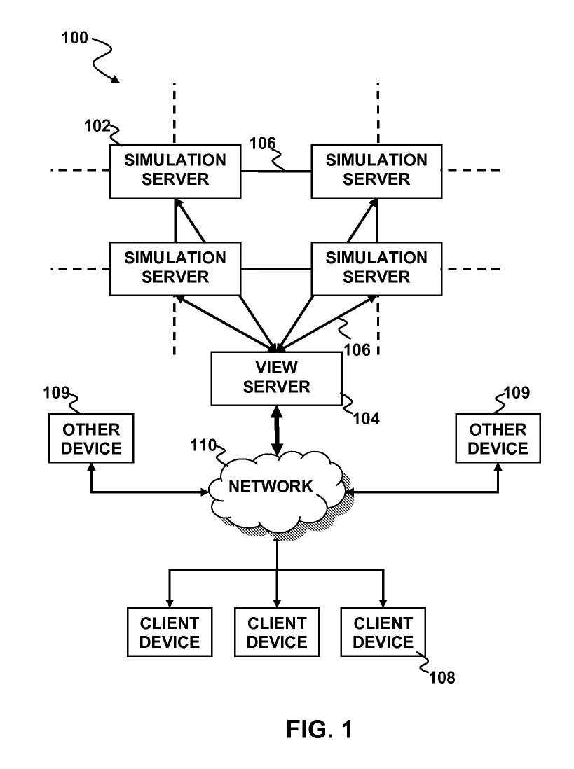

FIG. 1 is a schematic diagram illustrating an example of a system 100 that may be used to simulate a virtual world.

The system 100 includes simulation servers 102 and view servers 104. Each simulation server 102 may include one or more processor modules that execute coded instructions that simulate some part of the virtual world. By way of example, each simulation server may include one or more multiple core processors, e.g., a dual-core, quad-core or Cell processors. Although a limited number of simulation servers 102 and a single view server 104 are depicted in FIG. 1, this configuration may be arbitrarily extended to any number of servers. The numbers of simulation servers 102 and view servers 104 may both be scaled. For example one simulation server 102 may accommodate many view servers 104, or many simulation servers 102 may accommodate one view server 104. Adding more simulation servers 104 may allow for a bigger and/or better simulation of the virtual world. Adding more view servers 104 allow the system 100 to handle more users. Of course, the system 100 may accommodate both a bigger and better simulation and more users by adding more of both simulation servers 102 and view servers 104. Theoretically the number of simulation servers 102 may be infinitely scalable. However, given a finite level of network bandwidth, the number of view servers 104 may be reasonably expected to reach a finite limit after a certain number of users due to computation and network bandwidth limitations.

The simulation servers 102 may communicate with each other and with the view servers 104 via high speed data transfer links 106. By way of example, the data transfer links may be 10 gigabit per second Ethernet connections. The simulation servers 102 may be either remotely located with respect to each other or they may be located proximate each other. To optimize data transfer it may be desirable to locate the simulation servers 102 in fairly close physical proximity, e.g., within the same room or on the same server rack. The view servers 104 receive simulation data from the simulation servers 102 and send view data to remotely distributed client devices 108 over a wide area network 110, such as the Internet. The client devices 108 may be any suitable device that can communicate over the network 110. Communication over the network 110 may be slower than over the fast data links 106.

By way of example, the client devices 108 may be video game console devices, such as the Sony PlayStation 3. Alternatively, the client devices 108 may be any computer device from handheld to workstation, etc. A handheld video game device, such as a PlayStation Portable from Sony Computer Entertainment of Tokyo, Japan is one example among others of a handheld device that may be used as a client device 108 in embodiments of the present invention. The client devices 108 may send the view servers 104 instructions relating to their desired interaction with other clients' avatars and with the simulated environment. For example, a client user may wish to move his or her avatar to a different portion of the simulated environment. Each client device 108 sends instructions to one of the view servers 104. These instructions are relayed by the view servers to the simulation servers that perform the necessary computations to simulate the interactions.

Other devices 109 may also communicate with each other over the network 110. Examples of such other devices include, telephones, cellular phones, voice over internet protocol (VoIP) phones, personal computers, portable web browsers, portable email devices, text messaging devices, portable game devices and the like. Communication between such other devices 109 may be independent of the simulation servers 102 and view servers 104 that generate the virtual world. Although the other devices 109 are not considered part of the system 100, they may interact with it via the network 110.

The users of the client devices 108 are often interested in things around them. The view servers 104 make sure that each client device 108 receives relevant data about its surroundings in the proper order. The view servers 104 determine what the client needs based on its avatar's location, orientation, motion, etc. By way of example, each view server may generate the code and/or data that the client devices use to present views of the public spaces or private spaces to their users.

Virtual worlds often represent users with avatars. As used herein, an avatar is a computer-generated character. In most cases, avatars are ‘humanoid’ in nature, as we tend to select representations that we can relate to. Examples of online worlds with avatars include PlayStation Home—Sony Computer Entertainment, Second Life—Linden Labs, World Of Warcraft (player selection screen)—Blizzard, and Free Realms—Sony Online Entertainment.

Selecting a default avatar or prioritizing a list of default avatars with as much information as possible, specifically where the user is not required to provide additional information or fill out multiple forms, would be a substantial step towards meeting the end-user's needs. This process involves maximizing information that can be obtained about the user from indirect sources such that the user is offered a set of defaults that are more to his liking. Census data can provide a statistically significant jump in the selection of the avatar ethnicity/gender, and geo-ip mapping can provide an unobtrusive means to correlate the user's location to a geo-location to determine ethnic/gender makeup of a community from census data. Additionally, socio-economic data tied to a user's location can provide further guidance in presenting a default avatar. Furthermore, supplemental sources of data such as feedback from users regarding their past preferences for avatar creation can also be used.

According to an embodiment of the present invention, a plurality of avatars is displayed as a set of defaults at the viewer screen. The avatars selected (up to some predetermined number N) represent the top N most likely ethnicities within the user's region, based on the census data, with the top prioritized avatar representing the region's highest ethnic population, and sorted in descending order based on ethnic population. The most granular geographic correlation is used, so that for places lacking detailed city-level census data, the ‘county’ data is used. If the ‘county’ level data is missing, then ‘state’ data, and so forth is used. For example, if the externally visible Internet IP address maps to an ISP datacenter in Okinawa, Japan, then the default avatar(s) selected would be Japanese, followed by White American (as there's a US military based in that city comprising the next largest population segment and hence most likely scenario given a random selection from the pool). If the externally visible Internet IP address maps to a datacenter in Bombay, India, then an Indian avatar would be shown. The avatars following would be prioritized in order of the region's ethnic population. The idea being that these defaults are easy to select, and provide users with a simple way to create avatars that most likely reflect themselves.

Where applicable, ethnicity and even gender may be inferred from the geographic location that an IP address maps to. The recommendation to place a plurality of avatars in a prioritized ordering is made to increase the probability that the target consumer's desired choice is shown on the default selection screen. If a specific area has a higher percentage of females than males, then it would stand to reason that the default screen shows the ‘cursor’ selection defaulting to the female.

The system may also be designed to learn. A user's past avatar selection preferences (or the selection preferences of other users known to have some association with the user) could be fed back to the system in order to help present a set of default avatars that more accurately reflect the user's preferences. In this case, the default selections presented for a given IP address geographic mapping would ‘start’ with census data to an uninitialized data set, but depending upon the feedback from actual prior selections made, could be made to more heavily weight the other choices. These prior selections may include past preferences from just the current user or may be pooled together with past preferences from other users that share a similar geographic location or other association with the current user.

This may ultimately result in the newly weighted avatar prioritization differing from the census-based defaults, but at the very least the census defaults would have provided a better-than-nothing starting point.

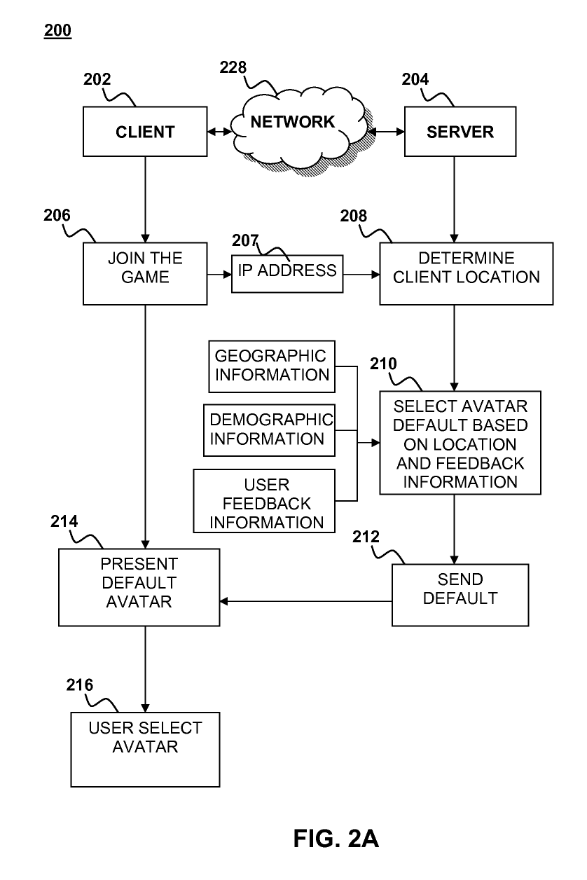

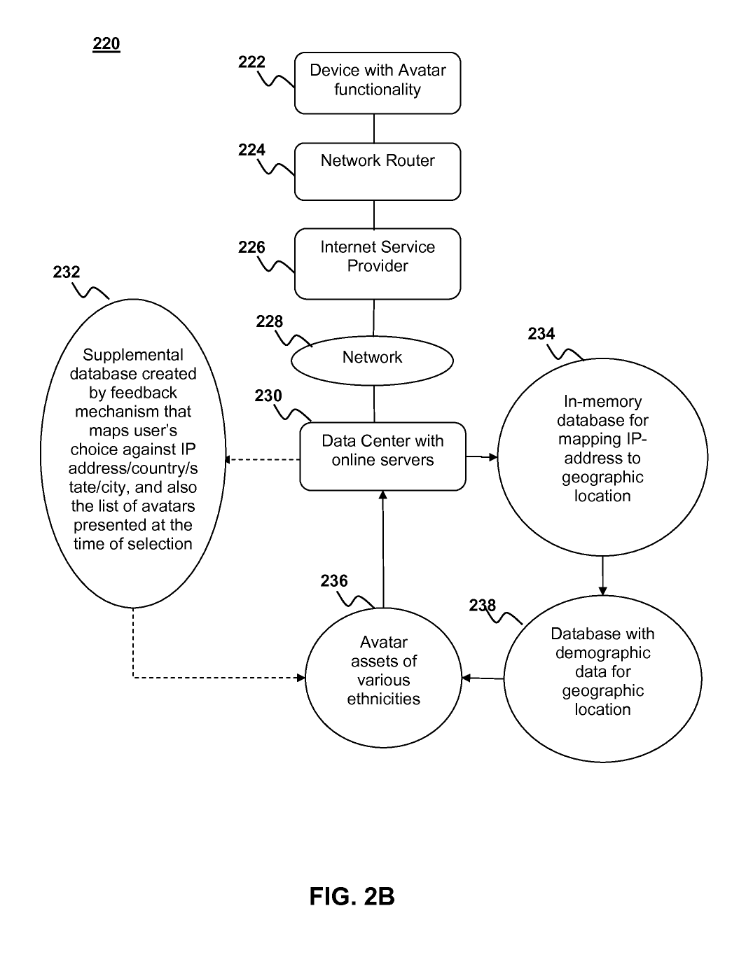

FIG. 2A is a block diagram illustrating a method 200 for leveraging geo-ip to select a default avatar according to an embodiment of the present invention. A client 202 initially joins a game as indicated at 206. The client 202 inputs its IP address as indicated at 207 to a simulation server 204. The client 202 and server 204 are connected through a network 228, which is used to facilitate communication and the transfer of information. The server 204 determines the location of the client 202 by mapping the client's IP address to a particular location using a commonly available geographic database as indicated at 208. The geographic database may relate the client's IP address to a geographic location, e.g., in terms of Latitude and Longitude, Country, State, City, or address within a city. The server 204 then selects an avatar default set based on the client device's geographic location, demographic information for that location, and user feedback as indicated at 210. The client's geographic location can be compared against a census database to obtain an initial set of default selections. The initial default selections can be updated with feedback from one or more supplemental databases (e.g., a feedback database containing feedback of past preferences for other client devices from the geographic location) to determine an optimal avatar default set. The selected avatar default set is sent back to the client 202 and presented at the client's screen as indicated at 212 and 214 respectively. The client 202 finally selects the appropriate avatar as indicated at 216.

FIG. 2B is a block diagram of a virtual world system 220 for selecting default avatar according to an embodiment of the present invention. A device 222 with avatar functionality of a user, such as a gaming console or portable gaming device, is connected to a network router 224 that is connected to an Internet Service provider 226. The device 222 then provides its globally visible Internet IP Address into the internet service provider 226. The globally visible Internet IP Address is used to map the location of the device 222 to a particular location via a commonly available IP-Address to geographic location database as mentioned above. By way of example, an IP address-to-geographic location database may map IP addresses to internet service providers via a database lookup. There are companies that collect data regarding which IP address ranges map to which cities or latitude-longitude coordinates. This data service can be relatively cheap, e.g., $300-$350 per hosting machine.

The Internet service provider 226 contacts the Data Center with online server 230 through a network 228 to get the user's location. The Data Center 230 then searches the first data source 234, which is an In-memory database, for mapping IP-address to geographic location, for example Country/State/City. The derived location is used as input to a secondary data source 238, which is a database with demographic data for the geographic location, such as the Census Database with information containing population breakdown by Country/State/City including ethnicity ratios. The ethnic breakdown of the location is pulled, and the top N choices identified. For example, if an IP address for a device maps to a location in Tokyo and census data indicates 98% of the people in Tokyo are Japanese the avatar selection criteria accordingly could be prioritized so that avatars with Japanese features are presented with higher priority.

To further enhance the avatar selection, a supplemental database 236 can be created by feedback mechanism that maps a user's choice against the geographic location and also the list of avatars presented at the time of selection. Areas for optimization include the selection algorithm that maps the geographic location to an ethnicity. Other criteria could potentially be blended in to the selection criteria, such that the end goal of having the user's preferred avatar being among the top-N default selection is achieved.

For example, if socio-economic factors determine that the user of the online service typically comes from a well-to-do background due to the cost of purchase/ownership of the device (or cost of the service), then these factors may be used to select the ethnicities in the population segment which correspond to the well-to-do people.

Sources other than census data, i.e., dynamic data, may be used to optimize the selection of the default set of N ethnicities. If after some period of usage, a particular location (e.g., lat/long/country/state/city) is showing a higher-than-normal selection of avatars with particular features such data could be used to affect the weighting of the ethnicities returned. For example, a feedback loop can inform the online service which avatars have been selected for a given geographic location. This information can be stored in a supplemental data source 236 parallel to ethnicity information. This type of feedback allows the service to prioritize avatar selection on a highly localized basis even if localized socioeconomic data are not available from a commercially or publicly available database service.

For example, suppose a user from the US Embassy in Tokyo is using the online service to select an avatar. At first, the user receives a set of default avatars that contain Japanese and other Asian nationalities in the selection screen. This person selects ‘American’ by scrolling beyond the default offerings. As several other people begin to do this from client devices with IP addresses that map to locations within the vicinity of the US Embassy in Tokyo, the system can then take note of the avatar selections coming from IP addresses within this particular location and begin to offer subsequent users from that location (e.g., at the IP address level) an American avatar as part of the default Avatar set.

The Data Center 230 can then input information derived from the secondary data source 238 as well as information derived from the supplemental database 236 into a third data source 232. This third data source 232 contains graphical avatar assets that correspond to the ethnicities available to be used as Online Avatars and is configured to obtain the top N choices for avatars having the features identified by the preferences obtained from the secondary database 238 and the supplemental database 236. These N choices are then presented back to the user as a set of default preferences prioritized by the most likely candidates. With this technique avatar selection can be associated with local characteristics as well as a user's prior selection preferences.

By way of example, and not by way of limitation, the technology described above may be used for sports games in which a user selects a team. The system can determine that the client device is in a particular location and then prioritize the default team selections so that local teams/local preferences are higher priority default selections. For example, this method can be used to prioritize a local college team for locations that are closest to a college or for foreign locations with ties to the college team.

As noted above, embodiments of the present invention may update the priority of the initial default selections based on feedback information obtained from the supplemental database. The feedback information can be used to update the default selection in a number of different ways. For example, the default selection can be updated to re-prioritize “what” is shown (e.g., the top-N default avatars). In addition, the default update can also prioritize “how long” an item is shown based on the value the algorithm decides is best. Higher priority items in an auto-updating interface can be presented on a display for a longer time than lower priority items. This gives an end-user more opportunity to interact with the higher priority items. Updating the default selection may therefore include changing a duration for which a particular selection from a sequence of selections is presented on the client device.

The technology of the present invention could be merged with social gaming such that a user may be recommended with people on his friends list who fit the default characteristics (e.g., Padres fans). For example, a user is an Anglo American in Japan who loves drag queens. His avatar and his friends' avatars reflect that. An online game does not normally have information about new users. However, if a new user is recommended by friends who are existing users, the game server can use additional information from the friends' use of the game to customize certain default selections presented to the new user.

The technology of the present invention could be used to choose race car drivers for racing games who represent the user's home country. Furthermore, this technology can be used to choose default downloadable content, priority, format, layout of information presented. The geographic information may be used to reflect local season, time of day based on city or lat-long lookup. In the prior art, a feature known as cookies has been used to provide default information to web users. For example, the website Weather.com presents the local weather for the location corresponding to the user's IP address by default. In addition, the website Yahoo.com allows users to customize the splash page with their preferences so that relevant information appears above a cut line. However, these websites do not take feedback from other users into account in customizing the appearance of the page that is presented to the user. Embodiments of the present invention, by contrast, allows new users to easily customize their avatars or splash pages based on their friends' preferences.

During avatar selection, the avatars displayed on the screen could transition (e.g., morph) from one default selection to another. The user may then make a selection upon seeing a specific avatar. The avatar selection program could determine which avatar is shown first and/or for the longest time based on census information or friends' information.

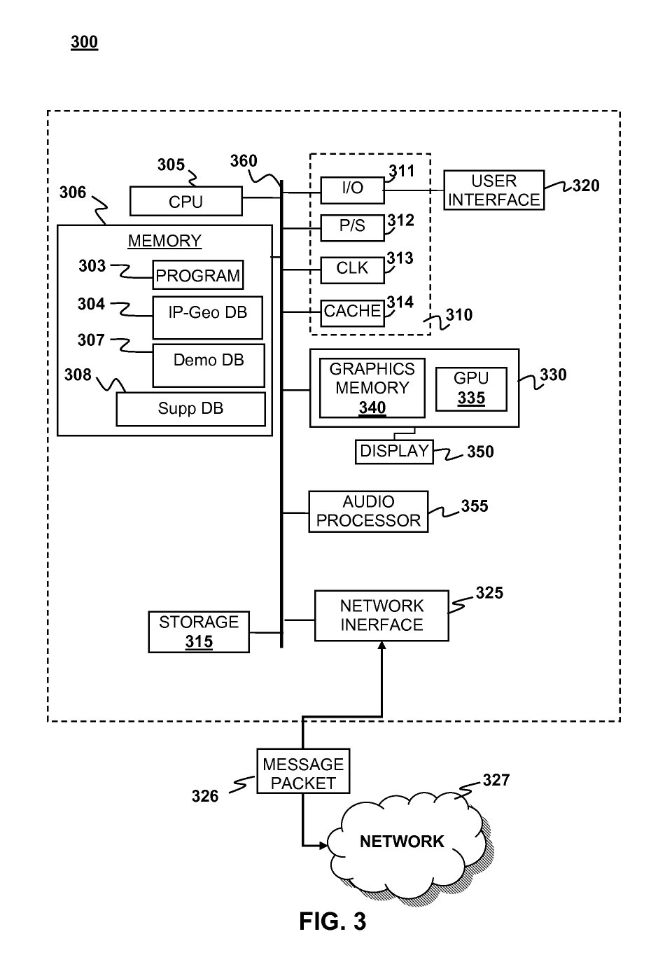

FIG. 3 is a block diagram illustrating the components of an information processing device 300 suitable for implementing a method for customization of default selections presented to a client device when the client device accesses an online service via a network 327. By way of example, and without loss of generality, the information processing device 300 may be implemented as a computer system, such as a personal computer, server, or other digital computation device, suitable for practicing embodiments of the invention. The processing device 300 may include a central processing unit (CPU) 305 configured to run software applications and optionally an operating system.

The CPU 305 may include one or more processing cores.

By way of example and without limitation, the CPU 305 may be a multi-core parallel processor system having multiple processing units that are configured to operate together as a system. One example, among others of a multi-core parallel processor system is a Cell Processor. An example of a Cell Processor architecture is described in detail, e.g., in Cell Broadband Engine Architecture, copyright International Business Machines Corporation, Sony Computer Entertainment Incorporated, Toshiba Corporation Aug. 8, 2005 a copy of which may be downloaded at http://cell.scei.co.jp/, the entire contents of which are incorporated herein by reference.

A memory 306 may be coupled to the CPU 305. The memory 306 may store applications and data for use by the CPU 305. The memory 306 may be in the form of an integrated circuit, e.g., RAM, DRAM, ROM, and the like). A computer program 303 may be stored in the memory 306 in the form of instructions that can be executed on the processor 305. The memory 306 may store geographic information 304 that relates one or more IP addresses for client devices to corresponding geographic locations. Such information may be obtained from a remote database that can be accessed via the network 327. Alternatively, the entire database, or a portion thereof may be stored in memory 306 or a storage device 315. The memory 306 may also contain demographic data 307 for one or more geographic locations. The demographic data 307 may include ethnic and/or socioeconomic distribution information for one or more locations. The demographic data may be obtained from a remotely located database or, alternatively, all or part of such a database may be stored in memory 306 or a storage device 315. The memory 306 may also include one or more supplemental databases 308 that contain information that maps feedback from users of an online service to one or more geographic locations.

The program 303 can include instructions configured for execution by the CPU 305. The instructions may be configured to implement a method for customization of default selections presented to a client device when the client device accesses an online service via the network 327.

The program 303 can be part of a larger program that allows one or more users to interact with a simulated environment via one or more client devices coupled to the information processing device 300 via the network 327. By way of example, and not by way of limitation, the program 303 may be part of a video game program or a virtual world simulation program.

The processing device 300 may also include well-known support functions 310, such as input/output (I/O) elements 311, power supplies (P/S) 312, a clock (CLK) 313 and cache 314. The processing device 300 may further include a storage device 315 that provides non-volatile storage for applications and data. By way of example, the storage device 315 may be a fixed disk drive, removable disk drive, flash memory device, tape drive, CD-ROM, DVD-ROM, Blu-ray, HD-DVD, UMD, or other optical storage devices.

One or more user input devices 320 may be used to communicate user inputs from one or more users to the processing device 300. By way of example, one or more of the user input devices 320 may be coupled to the processing device 300 via the I/O elements 311. Examples of suitable input device 320 include keyboards, mice, joysticks, touch pads, touch screens, light pens, still or video cameras, and/or microphones. A network interface 325 allows the processing device 300 to communicate with other computer systems via an electronic communications network 327. The network interface 325 may include wired or wireless communication over local area networks and wide area networks such as the Internet. The processing device 300 may send and receive data, e.g., broadcast messages, in the form of one or more message packets 326 over the network 327.

The processing device 300 may further comprise a graphics subsystem 330, which may include a graphics processing unit (GPU) 335 and graphics memory 340. The graphics memory 340 may include a display memory (e.g., a frame buffer) used for storing pixel data for each pixel of an output image. The graphics memory 340 may be integrated in the same device as the GPU 335, connected as a separate device with GPU 335, and/or implemented within the memory 306. Pixel data may be provided to the graphics memory 340 directly from the CPU 305. Alternatively, the CPU 305 may provide the GPU 335 with data and/or instructions defining the desired output images, from which the GPU 335 may generate the pixel data of one or more output images. The data and/or instructions defining the desired output images may be stored in memory 306 and/or graphics memory 340. In an embodiment, the GPU 335 may be configured (e.g., by suitable programming or hardware configuration) with 3D rendering capabilities for generating pixel data for output images from instructions and data defining the geometry, lighting, shading, texturing, motion, and/or camera parameters for a scene. The GPU 335 may further include one or more programmable execution units capable of executing shader programs.

The program 303 may interact with the graphics subsystem as follows. Execution of the program instructions may define and regularly update state values for user program assets, AI assets and other assets. These state values may determine position, orientation, motion, and actions for these assets. The program may convert these state values into values representing image components. The GPU 335 may convert the image component values to pixel data for an image. The pixel data may be temporarily stored in the graphics memory 340.

The graphics subsystem 330 may periodically output pixel data for an image from graphics memory 340 to be displayed on a display device 350. The display device 350 may be any device capable of displaying visual information in response to a signal from the processing device 300, including CRT, LCD, plasma, and OLED displays. In some embodiments, the display device may be part of a remote client device that is coupled to the processing device 300 over the network. The computer system 300 may provide the display device 350 with an analog or digital signal. By way of example, the display 350 may include a cathode ray tube (CRT) or flat panel screen that displays text, numerals, graphical symbols or images. In addition, the display 350 may include one or more audio speakers that produce audible or otherwise detectable sounds. To facilitate generation of such sounds, the system 300 may further include an audio processor 355 adapted to generate analog or digital audio output from instructions and/or data provided by the CPU 305, memory 306, and/or storage device 315.

The components of the processing device 300, including the CPU 305, memory 306, support functions 310, data storage 315, user input devices 320, network interface 325, graphics subsystem 330, and audio processor 355 may be operably connected to each other via one or more data buses 360. These components may be implemented in hardware, software or firmware or some combination of two or more of these.

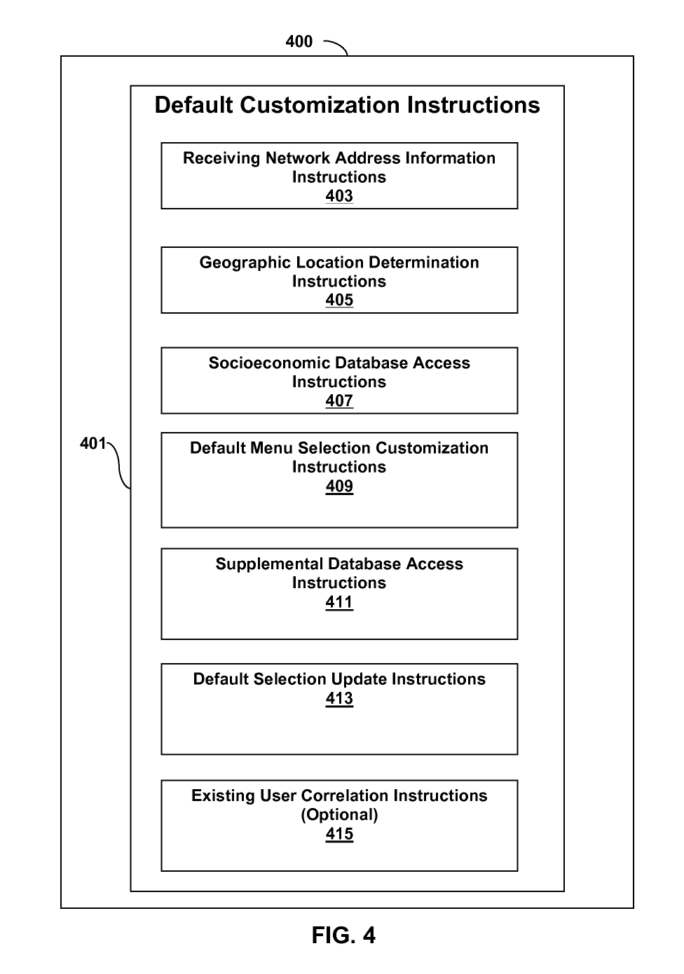

According to another embodiment, instructions for customization of default selections presented to a client device may be stored in a computer readable storage medium. By way of example, and not by way of limitation, FIG. 4 illustrates an example of a non-transitory computer-readable storage medium 400 in accordance with an embodiment of the present invention. The storage medium 400 contains computer-readable instructions stored in a format that can be retrieved, interpreted, and executed by a computer processing device. By way of example and not by way of limitation, the computer-readable storage medium 400 may be a computer-readable memory, such as random access memory (RAM) or read only memory (ROM), a computer readable storage disk for a fixed disk drive (e.g., a hard disk drive), or a removable disk drive. In addition, the computer-readable storage medium 400 may be a flash memory device, a computer-readable tape, a CD-ROM, a DVD-ROM, a Blu-Ray, HD-DVD, UMD, or other optical storage medium.

The storage medium 400 contains Default Customization Instructions 401 configured to customize default selections presented to a client device when the client device accesses an online service via a network. The Default Customization Instructions 401 may be configured to implement customization of default selections in accordance with the methods as described above with respect to FIG. 2B. In particular, the Default Customization Instructions 401 may include Receiving Network Address Information Instructions 403 that are used to obtain the client's globally visible internet IP address when executed on a processing device. The Default Customization Instructions 401 may further include Geographic Location Determination Instructions 405 that map the client's IP address to a geographic location through the use of databases described above, when executed by the processing device.

The Default Selection Customization Instructions 401 may also include Socioeconomic Database Access Instructions 407, which may be configured to gather relevant socio-economic factors associated with a client's location, when executed by the processing device. This may trigger execution of one or more Default Menu Selection Customization Instructions 409 that create a prioritized list of the top-N default selections based on the client's geographic location and socio-economic factors, when executed by the processing device.

The Default Customization Instructions 401 may additionally include Supplemental Database Access Instructions 411 that obtain supplemental information relevant to the menu selection from a second database when executed. The second database maps feedback relevant to menu selection from users of the online service that are located in similar geographic regions. Furthermore the Default Customization Instructions 401 may further include Default Selection Update Instructions 413 that update the default selection according to the supplemental information when executed. In addition, the Default Customization Instructions 401 may optionally include Existing User Correlation Instructions 415. Upon execution, the Existing User Correlation Instructions 415 may cause the device to determine whether the client device corresponds to a new user of the online service. Upon determination that the client device is being used by a new user, the existing user correlation instructions 415 would then cause the device to identify a relationship between the new user and the one or more existing users of the online service. In such a case, the supplemental information obtained by the Supplemental Database Access Instructions 411 may relate one or more characteristics of the new user to one or more corresponding characteristics of the existing users.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. Any feature, whether preferred or not, may be combined with any other feature, whether preferred or not. In the claims that follow, the indefinite article “A”, or “An” refers to a quantity of one or more of the item following the article, except where expressly stated otherwise. Any element in a claim that does not explicitly state “means for” performing a specified function, is not to be interpreted as a “means” or “step” clause as specified in 35 USC §112, 16. In particular, the use of “step of” in the claims herein is not intended to invoke the provisions of 35 USC §112, 16.

The reader's attention is directed to all papers and documents which are filed concurrently with this specification and which are open to public inspection with this specification, and the contents of all such papers and documents incorporated herein by reference.

What is claimed is:

1. A method for customization of default selections presented to a client device when the client device accesses an online service via a network, comprising:
receiving network address information from the client device;
determining a geographic location for the client device from the network address information;
obtaining socioeconomic information characteristic of the geographic location from a first database;
customizing a socioeconomic-factor-dependent default menu selection according to the socioeconomic information;
obtaining supplemental information relevant to the menu selection from a second database, wherein the second database maps feedback from users of the online service that is relevant to the menu selection in that geographic location;
updating the default selection according to the supplemental information.

2. The method of claim 1, further comprising:
determining whether the client device corresponds to a new user of the online service;
identifying a relationship between the new user and one or more other users of the online service; and
obtaining supplemental information from the relationship, wherein the supplemental information relates one or more characteristics of the new user of the online service to one or more corresponding characteristics of the other users.

3. The method of claim 2 wherein identifying the relationship includes receiving a recommendation of the new user from the one or more other users.

4. The method of claim 1 further comprising presenting a socioeconomic-factor-dependent default menu selection to the client device.

5. The method of claim 1 wherein updating the default selection includes changing a priority of selections presented on the client device.

6. The method of claim 1 wherein updating the default selection includes changing a duration for which a particular selection from a sequence of selections is presented on the client device.

7. The method of claim 1 wherein the determined geographic location is used as input to a data source for determining an ethnic distribution of a population of the target location.

8. The method of claim 1 further comprising obtaining the top N-choices from a data source containing graphical avatar assets.

9. A system, comprising:
a processor unit;
a memory coupled to the processor unit;
a set of processor executable instructions embodied in the memory, the instructions being configured, when executed, to implement a method for customization of default selections presented to a client device when the client device accesses an online service via a network, the method comprising:
a) receiving network address information from the client device;
b) determining a geographic location for the client device from the network address information;
c) obtaining socioeconomic information characteristic of the geographic location from a first database;
d) customizing a socio-economic-factor dependent default menu selection according to the socioeconomic information;
e) obtaining supplemental information relevant to the menu selection from a second database, wherein the second database maps feedback from users of the online service that is relevant to the menu selection in that geographic location;
f) updating the default menu selection according to the supplemental information.

10. The system of claim 9, further comprising:
determining whether the client device corresponds to a new user of the online service;
identifying a relationship between the new user and one or more other users of the online service; and
obtaining supplemental information from the relationship, wherein the supplemental information relates one or more characteristics of the new user of the online service to one or more corresponding characteristics of the other users.

11. The system of claim 10, wherein identifying the relationship includes receiving a recommendation of the new user from the one or more other users.

12. The system of claim 9, further comprising presenting a socioeconomic-factor-dependent default menu to the client device.

13. The system of claim 9, wherein updating the default selection includes changing a priority of selections presented on the client device.

14. The system of claim 9, wherein updating the default selection includes changing a duration for which a particular selection from a sequence of selections is presented on the client device.

15. The system of claim 9, wherein the determined geographic location is used as input to a data source for determining an ethnic distribution of a population of the target location.

16. The system of claim 9, further comprising obtaining the top-N choices from a data source containing graphical avatar assets.

17. A computer program product comprising:
a non-transitory computer-readable storage medium having computer readable program code embodied in said medium for customization of default selections presented to a client device when the client device accesses an online service via a network, said computer program product having:
a) computer readable program code means for receiving network address information from the client device;
b) computer readable program code means for determining a geographic location from the network address information;
c) computer readable program code means for obtaining socioeconomic information characteristic of the geographic location from a first database
d) computer readable program code means for customizing a socio-economic-factor dependent default menu selection according to the socioeconomic information;
e) computer readable program code means for obtaining supplemental information relevant to the menu selection from a second database, wherein the second database maps feedback from users of the online service that is relevant to the menu selection in that geographic location;
f) computer readable program code means for updating the default menu selection according to the supplemental information.

18. The computer program product of claim 17, further comprising computer readable program code means for:
determining whether the client device corresponds to a new user of the online service;
identifying a relationship between the new user and one or more other users of the online service; and
obtaining supplemental information from the relationship, wherein the supplemental information relates one or more characteristics of the new user of the online service to one or more corresponding characteristics of the other users.

19. The computer program product of claim 18, wherein identifying the relationship includes receiving a recommendation of the new user from the one or more other users.

20. The computer program product of claim 17, further comprising computer readable program code means for presenting a socioeconomic-factor-dependent default menu selection to the client device.

21. The computer program product of claim 17, wherein updating the default menu selection includes changing a priority of selections presented on the client device.

22. The computer program product of claim 17, wherein updating the default selection includes changing a duration for which a particular selection from a sequence of selections is presented on the client device.

23. The computer program product of claim 17, wherein the determined geographic location is used as input to a data source for determining an ethnic distribution of a population of the target location.

24. The computer program product of claim 17, further comprising computer readable program code means for obtaining the top-N choices from a data source containing graphical avatar assets.
